(19) United States
(12) Patent Application Publication
(10) Pub. No.: US 2017/0049100 A1
(43) Pub. Date: Feb. 23, 2017

(54) USE OF ALCOHOL(S) AS FUNGICIDE AND/OR ALGICIDE

(71) Applicant: OLEON NV, Evergem (BE)

(72) Inventors: Pierre RAVIER, Compiegne (FR); Matthieu CHATILLON, Compiegne (FR); Sébastien BARREAU, Noyon (FR)

(21) Appl. No.: 15/308,307

(22) PCT Filed: Apr. 30, 2015
(86) PCT No.: PCT/FR2015/051167

§ 371 Date: Nov. 1, 2016

(30) Foreign Application Priority Data
May 2, 2014 (FR) 1454027

(51) Int. Cl. A01N 31/02

(52) U.S. Cl. CPC A01N 31/02

(57) ABSTRACT

The present invention relates to the use of an alcohol consisting of a linear or branched hydrocarbon-based chain having 7 to 9 carbon atoms, substituted with a single hydroxyl group, as a fungicide and/or algicide. It is more particularly directed towards combating the organisms of the family Pythiaceae. It is also directed towards compositions and preparations comprising these novel fungicides and/or algicides, and also the processes for obtaining same and the uses thereof.

The present invention relates to novel fungicides and/or algicides for controlling organisms of the family Pythiaceae and/or diseases caused by the latter. It also relates to compositions and preparations containing these novel fungicides and/or algicides, as well as methods for obtaining same and uses thereof.

The family Pythiaceae originates from the class Oomycota, which has for a long time been classified in the line of Fungi. Moreover, the on-line database on fungi, Mycobank, still identifies the family Pythiaceae as fungi. Nevertheless, researchers have recently shown that the Oomycota are better placed in the line of Heterokont algae, also called Stramenopile algae, rather than that of the Fungi. In this new classification, the Oomycota are then described as “fungiform”. For this reason, an active ingredient capable of controlling an organism of the family Pythiaceae and/or a disease caused by the latter, will be described as a fungicide and/or algicide.

A fungicide is a phytopharmaceutical product intended to control at least one fungus or fungiform organism or at least one disease caused by the latter, whereas an algicide is a phytopharmaceutical product intended to control at least one alga or the disease(s) caused by the latter.

By “phytopharmaceutical product” is meant an active ingredient or a composition containing one or more active ingredients, which is intended in particular to:
protect at least one plant against at least one harmful organism or to prevent the action thereof;
act on a vital process of a plant, to the extent that it does not involve nutritive substances (for example, growth regulators); and/or
ensure the preservation of a plant.

An active ingredient is a substance, including a micro-organism, which has a general or specific action on a harmful organism or on a plant. Non-limitatively, the active ingredients can be substances either of natural origin or originating from synthetic chemistry, which mimic natural substances, such as pheromones.

By “plant” is meant in particular a plant and/or a part of a plant, including a fruit, a vegetable or a seed.

Numerous active ingredients are currently used in order to protect crops, prevent the occurrence of phytopathogenic organisms and control the diseases that they cause. However, there is still a need for novel active ingredients, on the one hand because resistances to these substances are constantly developing and, on the other hand, because the majority of the substances used today have significant toxicity.

By way of example, propamocarb hydrochloride, which is used to control the organisms Pythium and Phytophthora and the diseases caused by the latter, can be mentioned. Propamocarb hydrochloride is considered to be able to cause lesions to the eyes and to decompose releasing dangerous gases when it is exposed to heat.

It must therefore be possible to propose effective novel substitute solutions that are less harmful to humans and more environmentally friendly.

Surprisingly, the work of the inventors has made it possible to show that certain alcohols could be used as fungicides and/or algicides in order to control the organisms of the family Pythiaceae.

Patent application FR2235644 discloses a method for controlling the diseases caused by the fungi that persist over the winter on woody plants, characterized in that said plants are treated in a dormant phase or when approaching a dormant phase, using a composition which comprises a surfactant which is a condensation product of an alkylphenol with ethylene oxide, and a fatty acid ester or fatty alcohol, in a given weight ratio. Now, ethoxylated alkylphenols are considered to be endocrine disrupters. The surfactant most used in the examples of the application, ethoxylated nonylphenol, would have a harmful effect on the aquatic ecosystems, and the degradation products thereof, such as nonylphenol, would be even more persistent in the environment and more toxic. This is why these surfactants are banned in certain countries, such as France. Moreover, the examples of this application describe a fungicidal action only with respect to apple powdery mildew (caused by Podosphaera leucotricha) and not with respect to any disease caused by one of the organisms of the family Pythiaceae. The disease specifically controlled is therefore caused by an organism different from the organisms targeted by the invention.

The present invention therefore relates to the use of an alcohol having 7 to 9 carbon atoms as a fungicide and/or algicide in order to control an organism of the family Pythiaceae and/or a disease caused by the latter.

By “control an organism”, is meant the act of killing the organism (curative effect), currently called fungus, fungiform organism and/or alga, preventing its occurrence (preventive effect), and/or controlling its proliferation.

By “control a disease caused by the organism”, is meant the act of eradicating the disease (curative effect), preventing its occurrence (preventive effect) and/or controlling its evolution and/or its propagation.

By “alcohol having 7 to 9 carbon atoms”, is meant more particularly a linear or branched alcohol having 7 to 9 carbon atoms. By “linear or branched”, is meant that the cyclic alcohols are specifically excluded. Even more particularly, the alcohol having 7 to 9 carbon atoms is an alcohol constituted by a linear or branched hydrocarbon chain having 7, 8 or 9 carbon atoms, substituted with a single hydroxyl group (OH). By “hydrocarbon chain”, is meant a chain constituted only by carbon and hydrogen atoms. In other words, the alcohol having 7 to 9 carbon atoms comprises no heterosubstituent other than the single hydroxyl group.

Advantageously, the alcohol is saturated.

Preferably, the alcohol having 7 to 9 carbon atoms has the following molecular formula:

CₙH₂ₙ₊₂O

in which n is an integer equal to 7, 8 or 9.

Heptanol (or heptan-1-ol), octanol (also called octan-1-ol or caprylic alcohol) or nonanol (or nonan-1-ol or pelargonic alcohol) can be mentioned as linear alcohols having 7 to 9 carbon atoms.

Octan-2-ol, 2-ethyl-hexanol, 7-methyl-octan-1-ol or 6-methyl-pentan-1-ol can be mentioned as branched alcohols having 7 to 9 carbon atoms.

The alcohol having 7 to 9 carbon atoms can be used alone or in a mixture with one or more other alcohols having 7 to 9 carbon atoms.

The alcohol having 7 to 9 carbon atoms is used as a fungicide and/or algicide and is also referred to hereafter as “the fungicide and/or algicide according to the invention”.

Advantageously, this alcohol can be obtained from renewable resources, such as from animal fats or vegetable oils.

Preferably, the organism of the family Pythiaceae is Pythium and/or Phytophthora.

By way of examples of organisms of these species, Phytophthora infestans, Phytophthora cinnamomi, Phytophthora ramorum, Phytophthora capsici, Phytophthora palmivora, Phytophthora fragariae, Phytophthora citrophthora and Phytophthora parasitica, Pythium sp., Pythium ultimum, Pythium aphanidermatum, Pythium irregulare and Pythium group F can be mentioned.

More preferentially, the fungicide and/or algicide according to the invention is used in order to control Pythium sp. and/or Phytophthora infestans and/or one or more disease(s) caused by the latter. An action targeted at these species of organisms allows selective control of Pythium sp. and/or Phytophthora infestans and/or the disease(s) caused by the latter. In particular, it has been shown that the fungicides and/or algicides according to the invention, and more particularly octanol, act on certain resistant strains of Pythium sp., in particular strains that are highly resistant to the phenylamide-type (FRAC code 4) and QoI-type (“Quinone outside inhibitors”, FRAC code 11) fungicides.

The FRAC (“Fungicide Resistance Action Committee”) codes correspond to a classification of the fungicides according to their mode of action. According to each mode of action, the fungicides are classified by chemical family, with which a code is associated (see the site http://www.frac.info/).

The diseases caused by the organisms Phytophthora and/or Pythium, are of two types:
the diseases which affect only or mainly the aerial part of the plant, such as a leaf, a stem and/or a fruit, caused by certain species of Phytophthora. For example, potato blight and tomato blight are caused by Phytophthora infestans; gummosis of the wood and brown rot of the fruits (mandarins and tangelos) are caused by Phytophthora citrophthora and Phytophthora parasitica.
the soil diseases which affect plant parts in contact with the soil, such as a root, the lower part of a stem, a tuber, a seed and/or a fruit which touches the soil. These diseases are caused mainly by Pythium as well as by a few species of Phytophthora. By way of example, raspberry root rot and strawberry red stele are caused by Phytophthora fragariae; collar rot and fruit rot in the cucurbits are caused by Phytophthora capsici; damping-off, also called root rot, which affects the roots of young plants, such as corn, cotton and soya bean, can be caused by Pythium.

Thus, the fungicide and/or algicide according to the invention can be used in order to treat a crop selected from the kitchen garden crops, ornamental crops, tropical crops, oleaginous crops, fruit crops and/or cereal crops, or a plant originating from these crops. The treatment can be carried out preventively or curatively. In particular, it can be carried out outside a period during which the plant is in dormant phase or approaching a dormant phase.

By “kitchen garden crops” is meant more particularly crops of potatoes, cabbages, aubergines, courgettes, pumpkins, salads (lettuce, escarole, lamb's lettuce), tomatoes, beans, peas, carrots, onions, turnips, spinach, chicons, endives, chicory, sweet peppers, greenhouse peppers, greenhouse cucumbers, alfalfa.

By “ornamental crops” is meant more particularly non-woody perennial plants, ornamental plants from bulbs, tubers or rhizomes, grasses, cacti, succulents, turf and lawns (including golf course greens), ornamental trees and bushes, in the open air or under protection, such as rose bushes, azaleas, rhododendrons, dahlias, begonias, nasturtiums, daisies, coleus, thujas.

By “tropical crops” is meant more particularly soya bean, rice and cotton crops.

By “oleaginous crops” is meant more particularly oilseed rape and flax crops.

By “fruit crops” is meant more particularly strawberries, raspberries, melons and citrus fruits such as lemons, limes, pomelos, mandarins and tangelos.

By “cereal crops” is meant more particularly rye and corn crops.

In particular, the fungicide and/or algicide according to the invention is used in order to treat crops of potatoes, tomatoes, corn, soya beans, rice, cotton and/or oilseed rape, or the plants originating from these crops. Even more particularly, the fungicide and/or algicide according to the invention, is suitable for the treatment of:
corn, soya beans, rice and cotton against the organism Pythium sp. and/or a disease caused by the latter, and
potatoes, tomatoes and oilseed rape against the organism Phytophthora infestans and/or a disease caused by the latter.

Advantageously, the fungicide and/or algicide according to the invention, used in order to treat the crops described above, is selected from the alcohols having 8 carbon atoms or a mixture thereof. The alcohol having 8 carbon atoms has all the particular and preferred characteristics of the alcohols having 7 to 9 carbon atoms. In particular, it is octanol, octan-2-ol and/or 2-ethyl-hexanol, preferably octanol.

Octanol, octan-2-ol and/or 2-ethyl-hexanol can advantageously be obtained from renewable resources such as vegetable oils. For example, octanol can be obtained by the reduction of caprylic acid, itself originating from coconut and/or palm-kernel vegetable oil. Octanol has low eco-toxicity and is easily biodegradable, more than 70% in 30 days. 2-ethylhexanol, which can be synthesized from plant raw materials, is also easily biodegradable, 100% in 5 days.

More particularly, octanol is used as a fungicide and/or algicide in order to:
control Pythium sp. and in particular sensitive and/or resistant strains of Pythium sp.,
control Phytophthora infestans and/or
control the disease(s) caused by these, such as potato blight, damping-off, for example corn damping-off.

According to an embodiment of the invention, the fungicide and/or algicide according to the invention is mixed with one or more other phytopharmaceutical product(s) such as a fungicide, an algicide and/or a growth regulator.

More particularly, the fungicide and/or algicide according to the invention is used in a mixture with another fungicidal and/or algicidal substance.

The other fungicidal and/or algicidal substance can be selected so as to obtain a mixture having a broadened spectrum of action. By “spectrum of action” is meant all of the activities of the mixture resulting from the sum of the activities of each of the fungicides and/or algicides. For example, the other fungicidal and/or algicidal substance can act on an organism other than those belonging to the family Pythiaceae, such as an organism belonging to the class Oomycota (apart from Pythiaceae), Deuteromycetes, Basidiomycetes, and/or Ascomycetes, and/or a disease caused by the latter.

The other fungicidal and/or algicidal substance can also be selected so as to obtain a mixture having at least two different modes of action targeting the same organism(s) in order to have increased effectiveness against one or more organism(s) of the family Pythiaceae and/or the disease(s) caused by the latter. The complementarity of the modes of action in fact makes it possible to act according to several modes of attack at the same time, which renders the fungicidal and/or algicidal mixture more effective. Moreover, the complementarity of the modes of action of such mixtures of fungicide(s) and/or algicide(s) makes it possible to overcome the resistances developed by the pathogenic organisms to certain active ingredients and to avoid creating resistances.

The association of the fungicide and/or algicide according to the invention with another fungicidal and/or algicidal substance has the advantage of being able to reduce the necessary quantity of this other fungicidal and/or algicidal substance while obtaining a similar result. This is particularly advantageous because the fungicide and/or algicide according to the invention can be of renewable origin, in particular of plant origin, whereas the majority of the fungicidal and/or algicidal substances currently used are of petrochemical origin and can present problems of toxicity for humans and/or for the environment. Reducing the quantity of substance(s) of petrochemical origin therefore has a great advantage in terms of human health and protection of the environment.

This reduction in the quantity of fungicidal and/or algicidal substance(s) of petrochemical origin is all the greater when a synergistic effect is observed between a fungicide and/or algicide according to the invention, in particular an alcohol or a mixture of alcohols having 8 carbon atoms, such as octanol, and another fungicidal and/or algicidal substance.

Moreover, it has been observed that this synergy can help to control and overcome resistances developed by the pathogenic organisms to certain active ingredients, such as the phenylamides and the QoIs.

By way of example, the association of octanol, octan-2-ol and/or 2-ethyl-hexanol with a fungicidal substance such as Fluazinam, makes it possible to more effectively control the organisms of the family Pythiaceae, while being more environmentally friendly due to the lower effective quantity of Fluazinam necessary in comparison with use of the latter alone. Preferably, a combination of octanol and Fluazinam is used.

More particularly, the fungicide and/or algicide according to the invention, which can be of renewable origin and biodegradable, could advantageously be used in organic farming.

Organic farming is a method of agricultural production which aims to limit the use of products originating from synthetic chemistry and favours products of renewable origin with low eco-toxicity.

The invention also relates to compositions containing an alcohol having 7 to 9 carbon atoms.

In particular, the invention relates to compositions containing an alcohol having 7 to 9 carbon atoms, as defined above.

According to a first embodiment of the invention, the composition comprises an alcohol having 7 to 9 carbon atoms and a product selected from the group constituted by paraffin, paraffinic mineral oil, hydrocarbon polymers, rapeseed oil, esterified rapeseed oil, in particular the methyl esters from rapeseed oil, fatty amine polymers, dimethyl polysioxane, the terpene alcohols, ethoxylated triglycerides, resins, polyvinyl alcohols, alpha olein sulphonate, the sulphuric esters, sulphonated fatty acid alcohols, diethylene glycol abietate, the polysorbates, acrylic polymers, vinyl acetate-maleic ester polymers, cellulose binders, potassium aluminosilicate, copper from copper tallate, the latexes, in particular synthetic, brilliant blue dye (or “acid blue”), pine oil, ammonium sulphate, the white mineral or petroleum oils, triethanolamine, the methyl esters from vegetable oil or fatty acids, polyoxyalkylated fatty alcohol phosphate esters, ethylene and propylene complex polymers, soya bean lecithin, ethyl oleate, luminaria digitata or mixtures thereof.

More particularly, the composition according to the invention comprises an alcohol having 7 to 9 carbon atoms and a product selected from the group constituted by paraffin, paraffinic mineral oil, hydrocarbon polymers, rapeseed oil, esterified rapeseed oil, in particular the methyl esters from rapeseed oil, dimethyl polysiloxane, the terpene alcohols, ethoxylated triglycerides, polyvinyl alcohols, alpha oleine sulphonate, the sulphur esters, sulphonated fatty acid alcohols, diethylene glycol abietate, the polysorbates, acrylic polymers, vinyl acetate-maleic ester polymers, cellulose binders, potassium aluminosilicate, copper from copper tallate, latexes, in particular synthetic, brilliant blue dye (or “acid blue”), white mineral or petroleum oils, vegetable oil or fatty acid methyl esters, or mixtures thereof.

Preferentially, the product mentioned above is an adjuvant. By “adjuvant” is meant a compound or a preparation devoid of phytopharmaceutical activity which, combined with an alcohol having 7 to 9 carbon atoms or with a mixture of these alcohols, improves the physical, chemical or biological qualities thereof, in particular the fungicidal and/or algicidal activity, while limiting the harmful effects and impacts on human beings, fauna and flora. The increase in fungicidal and/or algicidal activity can for example result from better vectorization or better targeting of the part to be treated and/or from an improvement in the stability of the fungicides and/or algicides, for example, by protecting them from ultra-violet light.

According to a particular embodiment, the composition comprises an alcohol having 7 to 9 carbon atoms and methyl esters from vegetable oil, in particular methyl esters from rapeseed oil.

The alcohol having 7 to 9 carbon atoms can be linear or branched. Heptanol (or heptan-1-ol), octanol (also called octan-1-ol or caprylic alcohol) or nonanol (or nonan-1-ol or pelargonic alcohol) can be mentioned as linear alcohols. Octan-2-ol, 2-ethyl-hexanol, 7-methyl-octan-1-ol or 6-methyl-pentan-1-ol can be mentioned as branched alcohols.

The alcohol can be used alone or in a mixture with one or more other alcohols having 7 to 9 carbon atoms.

Advantageously, the alcohol can be obtained from renewable resources, such as from animal fats or from vegetable oils.

Preferably, the alcohol is octanol, octan-2-ol and/or 2-ethyl-hexanol, preferably octanol.

Advantageously, the composition according to the invention also comprises a fungicidal and/or algicidal substance.

Preferably, the fungicidal and/or algicidal substance is suitable for the treatment of a crop selected from the kitchen garden crops, ornamental crops, tropical crops, oleaginous crops, fruit crops and/or cereal crops, as described previously or of a plant originating from these crops. In particular, the composition according to the invention is suitable for the treatment of potato, tomato, oilseed rape, soya bean, rice and/or cotton crops.

More particularly, the alcohol having 7 to 9 carbon atoms already having a fungicidal and/or algicidal activity, the composition according to the invention then comprises two fungicides and/or algicides.

According to a first embodiment, the composition according to the invention can have a broadened spectrum of action, by choosing in particular the fungicidal and/or algicidal substance from the group constituted by the phenylamides (FRAC code 4), the heteroaromatics (FRAC code 32), the carboxylic acids (FRAC code 31), the methyl-benzimidazole carbamates (FRAC code 1), the N-phenyl carbamates (FRAC code 10), the benzamides and thiazole carboxamides (FRAC code 22), the phenylureas (FRAC code 20), the benzamides (FRAC code 43), the pyridinamines and pyrazole-MET1s (FRAC code 39), the succinate dehydrogenase inhibitors (SDHI) (FRAC code 7), the QoIs (“Quinone outside inhibitors”) (FRAC code 11), the QiIs (“Quinone inside inhibitors”) (FRAC code 21), the dinitrophenyl crotonates and 2,6-dinitro-anilines (FRAC code 29), the organic tin compounds (FRAC code 30), the thiophene-carboxamides (FRAC code 38), the QxIs (“quinone x inhibitors”) (FRAC code 45), the anilino-pyrimidines (FRAC code 9), the enopyranuronic acid antibiotic (FRAC code 23), the hexopyranosyl antibiotic (FRAC code 24), the glucopyranosyl antibiotic: streptomycin (FRAC code 25), the tetracycline antibiotic (FRAC code 41), the aza-naphthalenes (FRAC code 13), the phenylpyrroles (FRAC code 12), the dicarboximides (FRAC code 2), the thiolates (FRAC code 6), the aromatic hydrocarbons and heteroaromatics (FRAC code 14), the carbamates (FRAC code 28), the microbes (FRAC code 44), the terpene plant extracts (FRAC code 46), the demethylation inhibitors (FRAC code 3), the amines (FRAC code 5), the hydroxyanilides and amino-pyrazolinones (FRAC code 17), the thiocarbamates and allylamines (FRAC code 18), the glucopyranosyl antibiotic: validamycin (FRAC code 26), the polyoxins (FRAC code 19), the amino acid carbamates (FRAC code 40), the melanin biosynthesis inhibitors (FRAC code 16.1 and 16.2), benzothiadiazole BHT, benzisothiazole, thiadiazole-carboxamide, polysaccharides and plant extracts (FRAC code P), the cyanoacetamide-oximes (FRAC code 27), the phosphonates (FRAC code 33), the phthalamic acids (FRAC code 34), the benzotriazines (FRAC code 35), the benzene-sulphonamides (FRAC code 36), the pyridazinones (FRAC code 37), the thiocarbamates (FRAC code 42), the phenyl-acetamides (FRAC code U6), the aryl-phenyl-ketones (FRAC code U8), the guanidines (FRAC code U12), the thiazolidines (FRAC code U13), the pyrimidinone-hydrazones (FRAC code U14), the inorganic fungicides (FRAC code M1 and M2), the dithiocarbamates and derivatives (FRAC code M3), the phthalimides (FRAC code M4), the chloronitriles (FRAC code M5), the sulphamides (FRAC code M6), the guanidines (FRAC code M7), the triazines (FRAC code M8), the quinones (FRAC code M9), the quinoxalines (FRAC code M10), the maleimides (FRAC code M11), the piperidinyl-thiazole-isoxazolines (FRAC code U15), 4-quinolyl-acetate (FRAC code U16), mineral oils, organic oils, potassium bicarbonate and compounds of biological origin.

More particularly, the fungicidal and/or algicidal substance can be selected from the group constituted by the phenylamides (FRAC code 4), the heteroaromatics (FRAC code 32), the carboxylic acids (FRAC code 31), the methyl-benzimidazole carbamates (FRAC code 1), the N-phenyl carbamates (FRAC code 10), the benzamides and the thiazole carboxamides (FRAC code 22), the phenylureas (FRAC code 20), the benzamides (FRAC code 43), the pyridinamines and pyrazole-METis (FRAC code 39), the succinate dehydrogenase inhibitors (SDHI) (FRAC code 7), the QoIs (“Quinone outside inhibitors”) (FRAC code 11), the QiIs (“Quinone inside inhibitors”) (FRAC code 21), the dinitrophenyl crotonates and 2,6-dinitro-anilines (FRAC code 29), the organic tin compounds (FRAC code 30), the thiophene-carboxamides (FRAC code 38), the QxIs (“quinone x inhibitors”) (FRAC code 45), the enopyranuronic acid antibiotic (FRAC code 23), the hexopyranosyl antibiotic (FRAC code 24), the glucopyranosyl antibiotic: streptomycin (FRAC code 25), the tetracycline antibiotic (FRAC code 41), the aza-naphthalenes (FRAC code 13), the phenylpyrroles (FRAC code 12), the dicarboximides (FRAC code 2), the thiolates (FRAC code 6), the aromatic hydrocarbons and heteroaromatics (FRAC code 14), the carbamates (FRAC code 28), the microbes (FRAC code 44), the terpene plant extracts (FRAC code 46), the imidazoles, triazoles and triazolinthiones (FRAC code 3), the amines (FRAC code 5), the hydroxyanilides and amino-pyrazolinones (FRAC code 17), the thiocarbamates and allylamines (FRAC code 18), the glucopyranosyl antibiotic: validamycin (FRAC code 26), the amino acid carbamates (FRAC code 40), the melanin biosynthesis inhibitors (FRAC code 16.1 and 16.2), benzothiadiazole BHT, benzisothiazole, thiadiazole-carboxamide, polysaccharides and plant extracts (FRAC code P), the cyanoacetamide-oximes (FRAC code 27), the phosphonates (FRAC code 33), the phthalamic acids (FRAC code 34), the benzotriazines (FRAC code 35), the benzene-sulphonamides (FRAC code 36), the pyridazinones (FRAC code 37), the thiocarbamates (FRAC code 42), the phenyl-acetamides (FRAC code U6), the aryl-phenyl-ketones (FRAC code U8), the guanidines (FRAC code U12), the thiazolidines (FRAC code U13), the piperidinyl-thiazole-isoxazolines (FRAC code U15), 4-quinolyl-acetate (FRAC code U16), the inorganic fungicides (FRAC code M1 and M2), the dithiocarbamates and derivatives (FRAC code M3), the phthalimides (FRAC code M4), the chloronitriles (FRAC code M5), the sulphamides (FRAC code M6), the guanidines (FRAC code M7), the triazines (FRAC code M8), the quinones (FRAC code M9), the quinoxalines (FRAC code M10), the maleimides (FRAC code M11), mineral oils, organic oils, potassium bicarbonate and compounds of biological origin.

According to a second embodiment, the composition according to the invention can have increased effectiveness against an organism of the family Pythiaceae and/or a disease caused by the latter, by choosing the fungicidal and/or algicidal substance from those also controlling an organism of the family Pythiaceae and/or a disease caused by the latter. This is even more the case if the modes of action of the alcohol having 7 to 9 carbon atoms and of the fungicidal and/or algicidal substance are different. The fungicidal and/or algicidal compositions thus obtained are effective while being less toxic to humans and the environment. The complementarity or the synergistic effect allows the use of a smaller quantity of conventional fungicides, for example of petrochemical origin, for a similar result.

More particularly, the fungicidal and/or algicidal substance is selected so as to act against an organism selected from Phytophthora and/or Pythium, even more particularly Phytophthora infestans and/or Pythium sp., and/or a disease caused by the latter. This leads to a fungicidal and/or algicidal composition intended for selectively controlling Phytophthora, Pythium and/or a disease caused by the latter. This fungicidal and/or algicidal composition are in addition particularly effective against the resistant strains of Pythium sp.

By way of example, the fungicidal and/or algicidal substance is selected from the group constituted by the amino acid carbamates (FRAC code 40), such as Dimethomorph, Valifenalate, Benthiavalicarb, Mandipropamid; the benzamides (FRAC code 22), such as Zoxamide; the benzamides (FRAC code 43), such as Fluopicolide, Propineb; cyanoacetamideoxime (FRAC code 27), such as Cymoxanil; the phenylamides (FRAC code 4), such as Benalaxyl, Mefenoxam or Metalaxyl; the QoIs (“Quinone outside Inhibitors” (FRAC code 11)), such as Pyraclostrobin, Famoxadone and Fenamidone; the 2,6-dinitro-anilines (FRAC code 29), such as Fluazinam; the QiIs (“Quinone inside Inhibitors” (FRAC code 21)), such as Cyazofamid; the carbamates (FRAC code 28), such as Propamocarb; the dithiocarbamates and derivatives (FRAC code M3), such as Mancozeb, Maneb and Metiram; the inorganic fungicides (FRAC code M1), such as copper hydroxide, copper sulphate, copper oxychloride, iron sulphate; the chloronitriles (FRAC code M5), such as Chlorothalonil; the QxIs (“Quinone x inhibitors” (FRAC code 45)), such as Ametoctradin; the phthalimides (FRAC code M4), such as Folpel or Folpet; the piperidinyl-thiazole-isoxazolines such as Oxathiapiprolin (FRAC code U15); Dazomet, Metam sodium and Gliocladium catenulatum.

More particularly, the fungicidal and/or algicidal substance can be suitable for the treatment of the soil, such as Propamocarb, Dazomet, Gliocladium catenulatum, Metam sodium.

Alternatively, the fungicidal and/or algicidal substance can be suitable for the treatment of the aerial part of plants, such as Fluazinam, Mancozeb, copper or a salt thereof, Cymonaxil, Folpet, Mandipropamid or Dimethomorph.

Preferably, the composition according to the invention comprises Fluazinam as a fungicidal and/or algicidal substance.

Preferentially, the compositions according to the invention comprise octanol as alcohol having 7 to 9 carbon atoms, and are used in order to control:
Pythium sp. and in particular the sensitive and/or resistant strains of Pythium sp.,
Phytophthora infestans and/or
the disease(s) caused by the latter, such as potato blight, damping-off, for example damping-off of corn.

The compositions according to the invention can also comprise a solvent, a surfactant and/or a second adjuvant.

By “solvent”, is meant a liquid under the conditions of use, which has the property in particular of dissolving or diluting other substances without causing any chemical modification of these substances and without itself being modified.

Any type of solvent can be used, preferably organic solvents, even more preferentially organic solvents of renewable origin, such as organic solvents of plant origin.

By “surfactant” also called surface active agent, is meant a compound which modifies the surface tension between two surfaces. Preferentially, the surfactants are ionic and/or non-ionic and agriculturally acceptable. Even more preferentially, the surfactants are of renewable origin, such as the alkyl polyglucosides, alkyl polypentosides and/or sorbitan esters.

The solvent and/or the surfactant can be introduced into the composition via the second adjuvant. In fact, an adjuvant can comprise a solvent and/or a surfactant.

By way of example, the following can be mentioned as adjuvants containing a solvent, alone or in combination with other compounds: an adjuvant based on methyl esters from animal fats or vegetable oils such as Actirob®B, Radiamix® or Vegestar® (methyl esters from rapeseed oil with surfactants marketed by Novance®), or also Adigor® marketed by Syngenta®, or such as Radia® 7961 (methyl esters from rapeseed oil) or Radia® 7064 (methyl esters from soya bean oil) marketed by Oleon®, an adjuvant based on phosphate esters of polyoxyalkylated fatty alcohols, fatty acid and oleic acid methyl esters such as Dash® HC by BASF®, an adjuvant based on methyl esters and guar, such as AgRho StarGuar® 4 EU by Rhodia®, an adjuvant based on isodecyl alcohol ethoxylate such as Trend® 90 marketed by DuPont®, an adjuvant based on terpene alcohols such as Heliosol® marketed by Action Pin®, an adjuvant based on ethyl esters from sunflower oil and surfactants such as TRS20 marketed by SDPO, an adjuvant based on rapeseed oil ethyl esters and surfactants such as Hasten® marketed by Victorian Chemicals, an adjuvant based on paraffinic mineral oil such as Banole® marketed by Total® and an adjuvant based on an emulsion of vegetable oils such as MexAgri® marketed by Mexel®.

By way of example, the following can be mentioned as adjuvant consisting of or containing one or more surfactant(s): an adjuvant based on methyl esters from animal fats or from vegetable oils and in particular the methyl esters from rapeseed oil with surfactant(s) such as Actirob®B, Radiamix® or Vegestar® marketed by Novance®, Mero® marketed by Bayer®, an adjuvant based on ethyl esters from sunflower oil and surfactants such as TRS2® marketed by SDPO, an adjuvant based on soya bean lecithin and propionic acid such as Li-7000 marketed by Agndyne®, an adjuvant based on ethoxylated fatty amine polymer and polysorbate 20 such as Surf 20000 marketed by Jouffray-Drillaud JD®, polysorbate 20 such as Tween® 20 marketed by Croda®, an adjuvant based on ethoxylated triglycerides such as Cantor® by Vivagro, and an adjuvant based on phosphate esters of polyoxyalkylated fatty alcohols, fatty acid and oleic acid methyl esters such as Dash® HC by BASF®.

Advantageously, when the adjuvant is an agriculturally acceptable adjuvant, it can contain one or more agents such as an antifoaming agent, an antifreeze agent, a thickening agent, a wetting agent, a retaining agent, a sticking agent, an anti-drifting agent or a stabilizing agent.

The majority of these adjuvants are particularly useful when the composition is intended to be emulsified in water then sprayed.

By “wetting agent” is meant an adjuvant which lowers the surface tension of the water thus allowing the droplet to spread over the target while reducing the contact angle.

By “retaining agent” is meant an adjuvant that promotes the sprayed droplets remaining on the target at the moment of impact.

By “sticking agent” is meant an adjuvant enabling better adhesion of the droplets sprayed onto the area to be treated at the moment of impact.

By “anti-drifting agent” is meant an adjuvant making it possible to not promote the creation of droplets that are too fine (<100-150μ) so as to obtain greater precision in the targeting of the sprayed product by reducing to the maximum the losses into the environment or towards neighbouring crops.

The invention also relates to a preparation containing a composition according to the invention and water, and to a method for obtaining the preparation by emulsion, dispersion or dilution of a composition according to the invention in water.

In fact, a composition according to the invention can be formulated as a concentrate to be diluted in, dispersed in or emulsified with water in order to obtain a preparation, which is then ready for use, i.e., suitable for application to a plant.

A concentrate is generally presented in liquid form (solution, emulsion or suspension), in gel form or in solid form (such as a powder, granules, a film). A concentrate is preferentially emulsifiable or dispersible in water.

The preparation can be presented in the form of solution, emulsion or suspension. Preferentially, the preparation is in the form of an emulsion for spraying.

Such a formulation allows the fungicides and/or algicides to be distributed homogeneously over the area to be treated during the application.

Optionally, during the production of the preparation it is possible to add an extemporaneous adjuvant.

The preparation according to the invention can be used as a fungicide and/or algicide, in a preventive and/or curative manner.

In particular, the compositions and the preparations according to the invention can be used in order to control an organism of the family Pythiaceae and/or a disease caused by the latter, more particularly, Pythium and/or Phytophthora, preferentially, Phytophthora infestans and/or Pythium sp.

The invention also discloses a fungicidal and/or algicidal composition for controlling an organism of the family Pythiaceae and/or a disease caused by the latter, containing an alcohol having 7 to 9 carbon atoms. More particularly, the fungicidal and/or algicidal composition is capable of controlling Pythium and/or Phytophthora, preferentially Phytophthora infestans and/or Pythium sp. The fungicidal and/or algicidal composition can have one or more of the features of the compositions described above.

According to a particular embodiment of the invention, the fungicidal and/or algicidal composition for controlling an organism of the family Pythiaceae and/or a disease caused by the latter, comprises a single active ingredient which consists of octanol, octan-2-ol and/or 2-ethyl-hexanol, preferably octanol.

The invention finally relates to methods for controlling an organism of the family Pythiaceae and/or a disease caused by the latter.

According to a first method, a plant to be treated is brought into contact with an effective quantity of a fungicide and/or algicide according to the invention or of a composition or preparation according to the invention.

By “effective quantity” is meant a quantity that is necessary and sufficient to control the organism and/or the disease caused by the latter. The term “dose” is also commonly used.

The effective quantity of an active ingredient can vary as a function of humidity and temperature. A person skilled in the art can determine by simple experimentation the quantity necessary to control the organism, such as a fungus and/or alga, or the disease caused by the latter.

According to a second method, the soil to be treated is brought into contact with an effective quantity of a fungicide and/or algicide according to the invention or of a composition or preparation according to the invention.

For example, a soil treatment can comprise the incorporation of the fungicide and/or algicide according to the invention, the composition according to the invention or the preparation according to the invention, in the compost before sowing, transfer to the nursery or repotting, or alternatively after cultivation.

The methods according to the invention are more particularly suitable for treating a plant and/or a soil intended for receiving plants within the framework of kitchen garden crops, ornamental crops, tropical crops, oleaginous crops, fruit crops and/or cereal crops as described above.

The treatments can be carried out preventively and/or curatively, preferably by spraying. The spraying is carried out onto the aerial part of a plant, such as the leaves, stems, fruits, flowers, ears, buds, bulbs and/or onto the soil to be treated, including the parts of a plant in contact with the soil, such as the collars, roots, tubers and seeds. For example, it may be a preventive treatment by spraying of the soil and/or onto the collar.

In general, a dose ranging from 0.2 to 10 L/ha of an alcohol having 7 to 9 carbon atoms is applied.

Preferentially, the treatments are aimed at controlling an organism of the family Pythiaceae and/or a disease caused by the latter, more particularly, Pythium and/or Phytophthora, preferentially, Phytophthora infestans and/or Pythium sp. The diseases caused by Phytophthora infestans and/or Pythium are for example damping-off, root rot, collar rot and/or blight.

Other characteristics and advantages of the invention will become apparent from the following examples, given by way of illustration, with reference to the figures which show respectively:

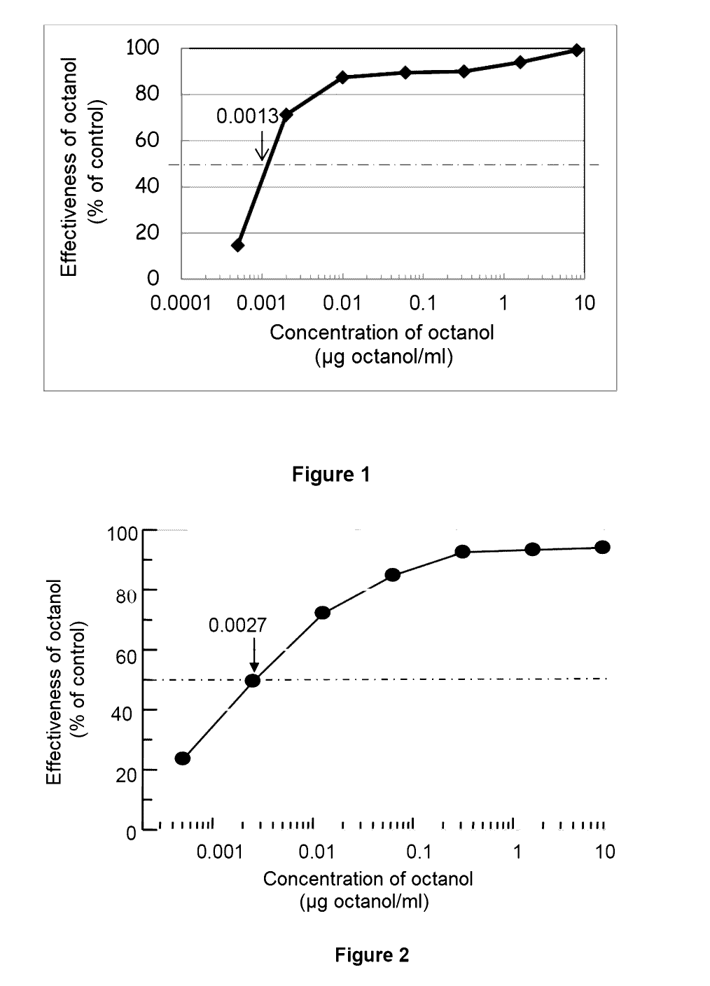

FIG. 1, a graph illustrating the results of effectiveness of octanol as a function of its concentration on a resistant strain of Pythium sp.,

FIG. 2, a graphic illustrating the results of effectiveness of octanol as a function of its concentration on a strain of Phytophthora infestans.

### EXAMPLE 1

### In Vitro Sensitivity of a Resistant Strain of Pythium sp.

The strain was isolated from chicory roots. It is highly resistant to the fungicidal substances belonging to the families of the phenylamides and QoIs.

4 mL of sterile distilled water is placed in a Petri dish. Sporocysts are added and following a temperature shock, they release the zoospores. After 24 hours, the spores released in the water are suspended in a doubly concentrated PDL (“Pea Dextrose Liquid”) medium. The concentration of the spores is adjusted to 500 spores/mL.

In microtitre plates, 100 μL of the suspension of spores at 500 spores/mL is added to 100 μL of a mixture containing distilled water, a quantity of octanol varying according to the desired concentration described below and of absolute ethanol which has a final constant concentration of 0.5% (v/v).

The octanol is diluted in absolute ethanol beforehand in order to obtain the following different concentrations: 0.000512-0.00256-0.0128-0.064-0.32-1.6 and 8 μg/mL.

After incubating for 7 days in darkness at 20° C. and under an atmosphere saturated with water vapour, the growth of the myceliums is assessed by measuring the optical density of each well of the microtitre plate at 590 nm using a plate reader. The sensitivity to octanol was defined by the quantity of substance inhibiting growth by 50%, the EC₅₀ (Effective concentration of the active ingredient which reduces the growth of the phytopathogen by 50%) determined from the optical density data using the Grafit 5.0 software (Erythacus Ltd.). The results are presented in FIG. 1.

Octanol is very effective against the resistant strain Pythium sp. The EC₅₀ calculated for octanol is equivalent to a concentration of 0.0013 μg of active ingredient/mL.

### EXAMPLE 2

### In Vitro Sensitivity of a Strain of Phytophthora Infestans

The strain was isolated from potato leaves. It is sensitive to all the fungicidal substances used to control potato blight.

The same protocol as that described previously was implemented with sporocysts of Phytophthora infestans, with the exception of the concentration of the spores which was adjusted to 2×10⁴ spores/mL and the incubation period adjusted to 5 days.

The results obtained are presented in Table 1 below as well as in FIG. 2.

TABLE 1

| Concentration | Effectiveness of octanol |
|---|---|
| (μg octanol/mL) | (% of control) |
| 0.000512 | 23.6 |
| 0.00256 | 49.4 |
| 0.0128 | 72.2 |
| 0.064 | 84.8 |
| 0.32 | 92.5 |
| 1.6 | 93.3 |
| 8 | 94.0 |

Octanol is highly effective against Phytophthora infestans. The EC₅₀ calculated for octanol is equivalent to a concentration of 0.0027 μg of active ingredient/mL.

### EXAMPLE 3

### In Vitro Sensitivity of a Strain of Phytophthora Infestans

The strain was isolated from potato leaves as previously.

The same protocol as that described in Example 1 was implemented with sporocysts of Phytophthora infestans, with the exception of the concentration of the spores which was adjusted to 2×10⁴ spores/mL and the incubation period adjusted to 5 days.

2-ethyl-hexanol was diluted in absolute ethanol beforehand in order to obtain the following different concentrations: 0.000512-0.00256-0.0128-0.064-0.32-1.6 and 8 μmg/L.

The results obtained are presented in Table 2 below.

TABLE 2

| | Effectiveness of |
|---|---|
| Concentration | 2-ethyl-hexanol |
| (μg 2-ethyl-hexanol/mL) | (% of control) |
| 0.000512 | 16.1 |
| 0.00256 | 42.3 |
| 0.0128 | 60.1 |
| 0.064 | 71.7 |
| 0.32 | 79.8 |
| 1.6 | 82.2 |
| 8 | 84.6 |

### Table 2

2-ethyl-hexanol is effective against Phytophthora infestans. The EC₅₀ calculated for 2-ethyl-hexanol is equivalent to a concentration of 0.0068 μg of active ingredient/mL.

### EXAMPLE 4

### In Plants Sensitivity of a Strain of Phytophthora Infestans—Preventive Treatment

Preparations Containing the Active Ingredient:

Octanol was mixed with sterile distilled water and Actirob B® marketed by Novance® (Actirob B is an emulsion in water at 842 g/L of methyl esters from rapeseed oil at 2 L/ha) in order to obtain compositions with the following doses of octanol: 0-0.5-1.0-3.0 and 6.0 L/ha.

Preparation of the Leaves:

Young potato leaves were collected and their surfaces disinfected. 12-mm discs were cut out using a cork borer under a laminar airflow. They are each randomized and placed in Petri dishes so that the lower parts of the leaves are in contact with sterile filter paper moistened with 3 mL of distilled water.

Preventive Treatment of the Leaves:

The different formulations containing the active ingredient or distilled water, which serves as a control, are applied to the disc-shaped leaves by spraying using a spray gun under a pressure of 2 bars. The sprayed quantity corresponds to the equivalent of 300 L/ha. For each condition, 2 repetitions of 6 discs each are carried out.

Preparation of a Calibrated Suspension of Spores of Phytophthora Infestans:

The strain was isolated from potato leaves.

Petri dishes containing a V8 Juice-CaCO₃-agar medium are seeded with a colony of mycelium of the strain of Phytophthora infestans. The Petri dishes are then incubated at 19° C. in darkness for 2 to 3 weeks. Then, 4 mL of sterile distilled water is introduced into each Petri dish and the spores are dislodged using a spatula and filtered through sterile Myracloth. The suspension is adjusted to 2×10⁵ spores/mL in cold sterile distilled water.

Inoculation of Phytophthora Infestans onto Potato Leaves:

The treated or untreated potato leaf discs are inoculated with 20 μL of the previously prepared suspension of spores of Phytophthora infestans.

The Petri dishes are then placed in an incubator at 23° C., at a relative humidity level of 100%, with alternating periods of 12 hours of light and 12 hours of darkness. After incubating for 5 days, the leaf surfaces are assessed and the inhibition of the different concentrations is calculated as follows:

% inhibition=(% untreated diseased leaf surface−% treated diseased leaf surface/% untreated diseased leaf surface)×100.

The results are shown in Table 3 below.

TABLE 3

| Treatment | dose | % inhibition |
|---|---|---|
| — | — | 0 |
| Octanol + Actirob B ® at 2 L/ha | 0.5 L/ha | 4.4 |
| | 1.01 L/ha | 9.8 |
| | 3.0 L/ha | 70.9 |
| | 6.0 I/ha | 86.1 |

Each value corresponds to the average of 12 observations per treatment.

It can be noted that octanol used at concentrations of 3 and 6 I/ha greatly reduces the intensity of the infection of the potato leaves caused by Phytophthora infestans inoculated after incubating for 5 days.

Octanol therefore has a preventive effect. Octanol controls the proliferation of Phytophthora infestans organisms in potatoes.

### EXAMPLE 5

### In Plants Sensitivity of a Strain of Phytophthora Infestans—Curative Treatment (Simultaneous Inoculation with Phytophthora Infestans and Fungicide)

Preparations containing the active ingredient: according to the same protocol as described in Example 4.

Preparation of the leaves: according to the same protocol as described in Example 4.

Preparation of a calibrated suspension of spores of Phytophthora infestans: according to the same protocol as described in Example 4 except that the suspension is adjusted to 4×10⁵ spores/mL in cold sterile distilled water.

Inoculation with the Treatment and the Pathogen Phytophthora Infestans:

0.5 mL of the suspension of spores is mixed with 0.5 mL of each of the preparations containing the active ingredient or with 0.5 mL of distilled water or with 0.5 mL of distilled water in the presence of Actirob B® at 2 L/ha. After inoculation, the Petri dishes are placed in an incubator at 23° C., at a relative humidity level of 100%, with alternating periods of 12 hours of light and 12 hours of darkness. After incubating for 5 and 7 days, each leaf is observed in order to assess the diseased leaf surfaces and calculate the inhibition of the different concentrations as follows: % inhibition=(% untreated diseased leaf surface−% treated diseased leaf surface/% untreated diseased leaf surface)×100. The results are shown in Table 4 below.

TABLE 4

| | | % inhibition | |
|---|---|---|---|
| | | after incubating | after incubating |
| Treatment | Dose | for 5 days | for 7 days |
| Control (no treatment) | — | 0 | 0 |
| water + Actirob B ® at | — | 0 | 0 |
| 2 L/ha | | | |
| octanol + Actirob B ® at | 0.5 L/ha | 100 | 100 |
| 2 L/ha | 1.0 L/ha | 100 | 100 |
| | 3.0 L/ha | 100 | 100 |
| | 6.0 L/ha | 100 | 100 |

Each value corresponds to an average of 12 observations per treatment.

When octanol is applied at the same time as Phytophthora infestans to the surface of potato leaves, this substance completely inhibits the development of this pathogen irrespective of the incubation period (5 or 7 days) and the dose used (0.5-1-3-6 L/ha).

Octanol therefore has a curative effect, by killing the organism Phytophthora infestans in potatoes.

1. A method of controlling an organism of the family Pythiaceae and/or a disease caused thereby comprising applying to a crop and/or soil an alcohol comprising a linear or branched hydrocarbon chain having 7 to 9 carbon atoms, substituted with a single hydroxyl group, as a fungicide and/or algicide.

2. The method according to claim 1, in which the organism of the family Pythiaceae is Pythium and/or Phytophthora.

3. The method according to claim 1, wherein the crop comprises kitchen garden crops, ornamental crops, tropical crops, oleaginous crops, fruit crops and/or cereal crops or a plant originating from these crops.

4. The method according to claim 1, in which the alcohol having 7 to 9 carbon atoms is octanol, octan-2-ol and/or 2-ethyl-hexanol.

5. The method according to claim 1, comprising applying a mixture of the alcohol having 7 to 9 carbon atoms with another fungicidal and/or algicidal substance.

6. A composition comprising an alcohol constituted by a linear or branched hydrocarbon chain having 7 to 9 carbon atoms, substituted with a single hydroxyl group, and a product comprising a paraffin, paraffinic mineral oil, hydrocarbon polymers, rapeseed oil, esterified rapeseed oil, fatty amine polymer, dimethyl polysiloxane, a terpene alcohols, ethoxylated triglyceride, resin, polyvinyl alcohol, alpha oleine sulphonate, sulphur ester, sulphonated fatty acid alcohol, diethylene glycol abietate, polysorbate, acrylic polymer, vinyl acetate-maleic ester polymer, cellulose binder, potassium aluminosilicate, copper from copper tallate, latex, brilliant blue (or “acid blue”) dye, pine oil, ammonium sulphate, white mineral or petroleum oils, triethanolamine, methyl ester from vegetable oil or fatty acids, phosphate ester of polyoxyalkylated fatty alcohols, ethylene and propylene complex polymer, soya bean lecithin, ethyl oleate, Luminaria digitata or mixtures thereof.

7. The composition according to claim 6 further comprising a fungicidal and/or algicidal substance.

8. The composition according to claim 7, in which the fungicidal and/or algicidal substance is suitable for the treatment of kitchen garden crops, ornamental crops, tropical crops, oleaginous crops, fruit crops and/or cereal crops, or of a plant originating from these crops.

9. The composition according to claim 7, in which the fungicidal and/or algicidal substance controls an organism of the family Pythiaceae and/or a disease caused thereby.

10. The composition according to claim 9, in which the fungicidal and/or algicidal substance is an amino acid carbamate, benzamide, cyanoacetamideoxime, phenylamide, QoIs (“Quinone outside Inhibitors”), 2,6-dinitro-aniline, QiI (“Quinone inside Inhibitor”), carbamate, dithiocarbamate and derivatives, inorganic fungicide, chloronitrile, QxI (“Quinone x inhibitor”), the phthalimide, piperidinyl-thiazole-isoxazoline, Dazomet, Metam sodium or Gliocladium catenulatum.

11. The composition according to claim 6, in which the alcohol having 7 to 9 carbon atoms is octanol, octan-2-ol and/or 2-ethyl-hexanol.

12. A preparation comprising the composition according to claim 6 and water.

13. A method for making the preparation according to claim 12, comprising emulsifying, dispersing or diluting in water, a composition comprising an alcohol constituted by a linear or branched hydrocarbon chain having 7 to 9 carbon atoms, substituted with a single hydroxyl group, and a product comprising a paraffin, paraffinic mineral oil, hydrocarbon polymer, rapeseed oil, esterified rapeseed oil, fatty amine polymer, dimethyl polysiloxane, terpene alcohol, ethoxylated triglyceride, resin, polyvinyl alcohol, alpha oleine sulphonate, sulphur ester, sulphonated fatty acid alcohol, diethylene glycol abietate, polysorbate, acrylic polymer, vinyl acetate-maleic ester polymer, cellulose binder, potassium aluminosilicate, copper from copper tallate, latex, brilliant blue (or “acid blue”) dye, pine oil, ammonium sulphate, white mineral or petroleum oil, triethanolamine, methyl ester from vegetable oil or fatty acids, phosphate ester of polyoxyalkylated fatty alcohols, ethylene and propylene complex polymer, soya bean lecithin, ethyl oleate, Luminaria digitata or mixtures thereof.

14-16. (canceled)

17. The composition according to claim 6, wherein the esterified rapeseed oil is a methyl ester from rapeseed oil.

18. The composition according to claim 6, wherein the latex is synthetic.
